(19) United States
(12) Patent Application Publication
(10) Pub. No.: US 2007/0169192 A1
(43) Pub. Date: Jul. 19, 2007

(54) Detection of system compromise by per-process network modeling

(75) Inventors: Ian J.B. Main, Salmo BC (CA); Jean Renard Ward, Arlington, MA (US)

Correspondence Address: LAW OFFICE OF DAVID H. JUDSON, 15950 DALLAS PARKWAY, SUITE 225, DALLAS, TX, 75248, US

(73) Assignee: Reflex Security, Inc.

(21) Appl. No.: 11/644,103

(22) Filed: Dec. 22, 2006

Related U.S. Application Data
(60) Provisional application No. 60/753,841, filed on Dec. 23, 2005.

(51) Int. Cl. G06F 12/14

(52) U.S. Cl. 726/22

(57) ABSTRACT

A computer system protection method monitors and evaluates per process network communications activity to determine whether the process has been compromised. In one embodiment, a network modeling scheme gathers data to build a model and then compares networking activities to the model as they occur. In an alternate embodiment, modeling is not required and the comparison is done of network data collected at one layer of a communication system to network-related data collected at another layer. As a result of a comparison and an indication of compromise, a given remedial action is taken.

### CROSS-REFERENCE TO RELATED APPLICATION

This application is based on and claims priority from provisional application Ser. No. 60/753,841, filed Dec. 23, 2005.

### BACKGROUND OF THE INVENTION

1. Technical Field

The present invention relates generally to computer system security.

2. Background of the Related Art

As has become well known in the field of computer security, no system can be protected from compromise completely. In particular, those computer systems that provide access to, or that make access to, services through some communications mechanism are subject to attack and compromise. This is particularly true of systems that perform network communications and that are accessible on the Internet. Each application that performs network activity with other machines is potentially vulnerable to attack. Indeed, a defect or bug in the application can be exploited to inject a payload of unauthorized code (sometimes referred to as “shell code”) that will then execute on the compromised system.

Thus, providing a means to detect that an attack payload is operating on a computer system often is vital to system security, because it is typically impossible to protect a system against all possible attack payloads. Of course, the majority of attacks are performed or at least initiated over networks and, often, the Internet. Attack payloads that are delivered remotely generally have the following relevant characteristics. They use a network communication channel to deliver the exploit, namely, by making use of a bug or defect in the software; alternatively, the exploit is delivered by other means, such as human engineering. Once the exploit code has been introduced into the application or the system, the exploit code begins running. To further communicate with the attacker, a communications channel must be available for use. In some cases, the channel used for exploitation may be re-used for further communication. In many exploits, however, this is not possible or practical. Thus, most often a new communication channel is established either within the exploited process or within a new process. This either will be of the form of a process listening for connections from its attacker, or a process connecting back to the attacker. A representative attack of this type was the recently reported Windows Bind Meterpreter exploit.

In most cases, except perhaps those payloads that are capable of re-using an existing communication channel (such as the channel used to introduce the payload), a new channel must be opened. If the communications channel is re-used, it is more difficult to detect. Re-using a channel and, in particular, co-opting a channel used to introduce a payload, may cause the normal communications of that application to cease functioning. This might lead the operator of the system to re-boot or to otherwise isolate the system, because in such case the communication channel would be seen as non-functional, or hung. It is undesirable (from the point of view of an attacker) for normal communications, such as the communications of a database server, to be disrupted by the payload. In particular, even in the absence of any particular means for detecting an attack or the operation of the payload, a loss of normal service or communications might result in the operator of the system shutting down and perhaps restarting the system. This has the undesirable side effect (once again, from the point of view of the attacker) of stopping the operation and, in effect, defeating the attack. For that reason, attackers generally avoid such re-use or co-opting of existing communications channels in an application that might otherwise inhibit the attack—namely, by drawing attention to it.

Known detector programs typically work by evaluating attack “signatures.” These programs have limitations in attempting to detect the presence of attacks, however. One limitation is that many of these programs work only with known attacks. In particular, the external data (e.g., signatures) for “should not be permitted” network streams usually can only be used to detect attacks that have already been discovered externally. Firewalls provide some additional protection, but they are often subject to circumvention. Another problem is failure of prior art detection schemes in the presence of updates. The external data (rules, signatures, and the like) for “should not be permitted” attacks are difficult to keep up-to-date, especially as authorized updates are added to the system. Still another problem is that the attack often can hide itself. The means of hiding often is intentionally and carefully crafted to prevent known techniques from detecting the exploit and the payload communications. Such techniques include, for example, using open ports in firewalls, and encrypting data to disguise its content on the network. A still further problem is complexity of implementation. In particular, the update, coordination, and implementation of potentially thousands to tens-of-thousands or more signatures, rules, or other external data can be exceedingly complex, especially when the correlation with those signatures must be implemented in a fashion suitable for real-time use. Still another problem is the complexity of management. Rule and policy systems are especially prone to complex management, which often places an infeasible burden on the user to configure, modify, reconfigure, and/or tailor the detector software to his or her particular situation, let alone to do so continually as changes occur to his or her system or use of the given system.

Other limitations in the known detection art are also known. These include the inability to know which application is producing the network stream. This additional information can be valuable for determining if the operations being performed are valid or not. Further, an inability to know which application is producing the network stream or communication limits the remediation that can be done. For example, it may be impossible or impractical to halt or block only the communications of concern, and it may only be possible or practical to block all communications to the system. Finally, firewalls that do operate on a per-process basis most likely are configured using a rules-based approach, which forces a large expense for their management, as noted above.

The present invention addresses these and other problems associated with the prior art.

### BRIEF SUMMARY OF THE INVENTION

It is an object of the invention to detect computer system compromise based on a violation of an invariant condition that relates network communications as seen by instrumentation within a system, to network communications as seen by instrumentation external to the system.

It is another object of the invention to protect a computer system by detecting discrepancies between communications activity at differing layers of a communications system. In this approach, communications information is collected at a first (higher) layer (e.g., by an application, the OS kernel, or other location) and compared to data collected at a second (lower) level (e.g., by the kernel, external network device or other), to verify the consistency of the communications channel. An analysis component then compares information about these two data streams (which each may be in the form of real-time telemetry or batch data, or both) to determine whether the system (or application, process or other code functionality, as the case may be) has been compromised.

In a representative embodiment, the method involves intercepting network communications within an operating system kernel or other application and reporting this information to a service. The service records information about each process and its network communication behavior. A model of networking communications is then built based on this information, preferably for each process under test. Thereafter, during a monitoring phase, the service compares network communications-related information and data to the networking model created for the given process or application. If the process under test begins performing new network operations as determined by the comparison logic, the service identifies a potential compromise and takes a given action (e.g., issuing an alert, inhibiting execution, restricting network access, performing a further analysis, or the like). The model may be updated periodically or continuously as new information is learned. While performing the model-based comparison, the networking connection data collected from within the operating system kernel may also be compared to that collected by a user-based program, and/or to that of an external networking monitoring device. A discrepancy in the communications between these layers is an indication of an attack payload attempting to hide communications, and appropriate action may then be taken (e.g., issuing an alert, restricting network access or the like).

Typically, an application or service on a computer system will perform limited network activity depending on its role in the system. When an exploit takes over the system, typically a new network connection is established, either by having the application listen on a new port for a connection from the attacker, or by connecting back to the attacker's system. As noted above, the latter approach works well (from the point of view of the attacker) in firewall environments, which often allow outbound, but not inbound, traffic. By using the technique of the present invention, such “new” network activities are noticed and flagged as a likely compromise of the application.

Thus, the present invention takes advantage of the fact that all remote attacks generally require use of network connections to deliver payloads and/or to further compromise the system or its security; thus, per-process network communications modeling and analysis as contemplated by the invention provides a very efficient and cost-effective way to detect such attacks.

While per-process networking detection works well, there are some exploits that deliberately hide their communications through a number of means, e.g., usually by subverting the operating system kernel or performing the communications from within the kernel itself. Hence the comparison of network communications activity at varying levels provides an ongoing verification that a given layer of the system has not been subverted to serve the attacker. For this methodology, the greatest coverage is realized when comparing the highest level (usually the application layer) to that of the lowest level (usually the physical layer).

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a computer system in which the present invention may be implemented;

FIG. 2 illustrates one embodiment of the present invention; and

FIG. 3 illustrates an alternate embodiment of the invention.

### DETAILED DESCRIPTION OF AN ILLUSTRATIVE EMBODIMENT

As will be seen, the present invention contemplates using network activity monitoring in several different ways. In one embodiment, a network modeling scheme gathers data to build a model and then compares networking activities to the model as they occur. This embodiment may be carried out within the computer system itself. In an alternate embodiment, modeling is not required and the comparison is done of network data collected at one layer of a communication system to network-related data collected at another layer.

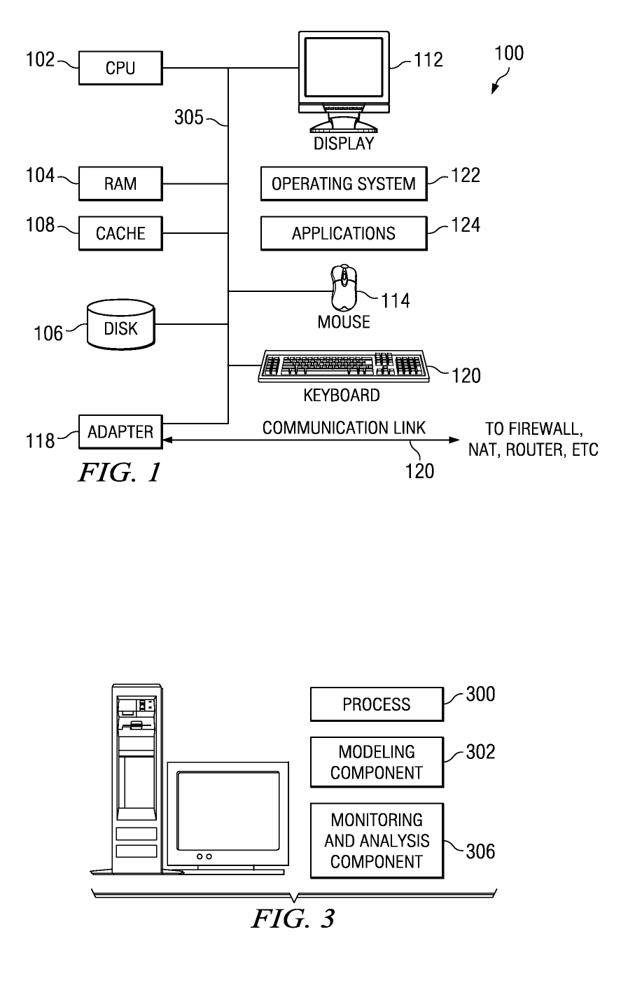

A computer or data processing system 100 in which the present invention may be implemented is illustrated in FIG. 1. This system is representative, and it should not be taken to limit the present invention. The system includes processor 102 coupled to memory elements through a system bus 105. The memory elements include local memory 104 employed during actual execution of the program code, disk storage 106, as well as cache memory 108 that provides temporary storage of program code and data. Input/output devices, such as a keyboard 110, a display 112, a pointing device 114, and the like, are coupled to the system either directly or through intervening I/O adapters or controllers (not shown). A network adapter 118 enables the system to become coupled to other systems or devices through intervening private or public networks 120. The system includes an operating system 122 and one or more application programs and utilities 124. Familiarity with basic operating system principles (including, without limitation, the concepts of operating system kernel space and user space) is presumed in the following discussion.

The computer system of FIG. 1 is assumed to access a network via a device such as a firewall, a NAT device, a router, or some other device or system. As is well-known, firewalls protect a computer against dangers on the Internet by monitoring or “policing” all packets that are sent from or to the protected computer(s) and by filtering out those portions of packets that violate an applicable firewall policy. A network address translation (NAT) device allows multiple computers to share a single public IP address. In this type of environment, multiple computers are placed on an internal network, and each computer is assigned a “private” IP address that is unique only within the internal network; the computers are then configured to access the Internet via the NAT device. The NAT device dynamically modifies the IP addresses found in IP packets sent by the computers in the internal network to make it appear that the internal computers are accessing the Internet from their shared address (as opposed to the private IP address used in the internal network). As used herein, these and similar devices are typically located between a computer system and the network and, as described below, they are thus useful sites for an “external” network monitoring function of the present invention.

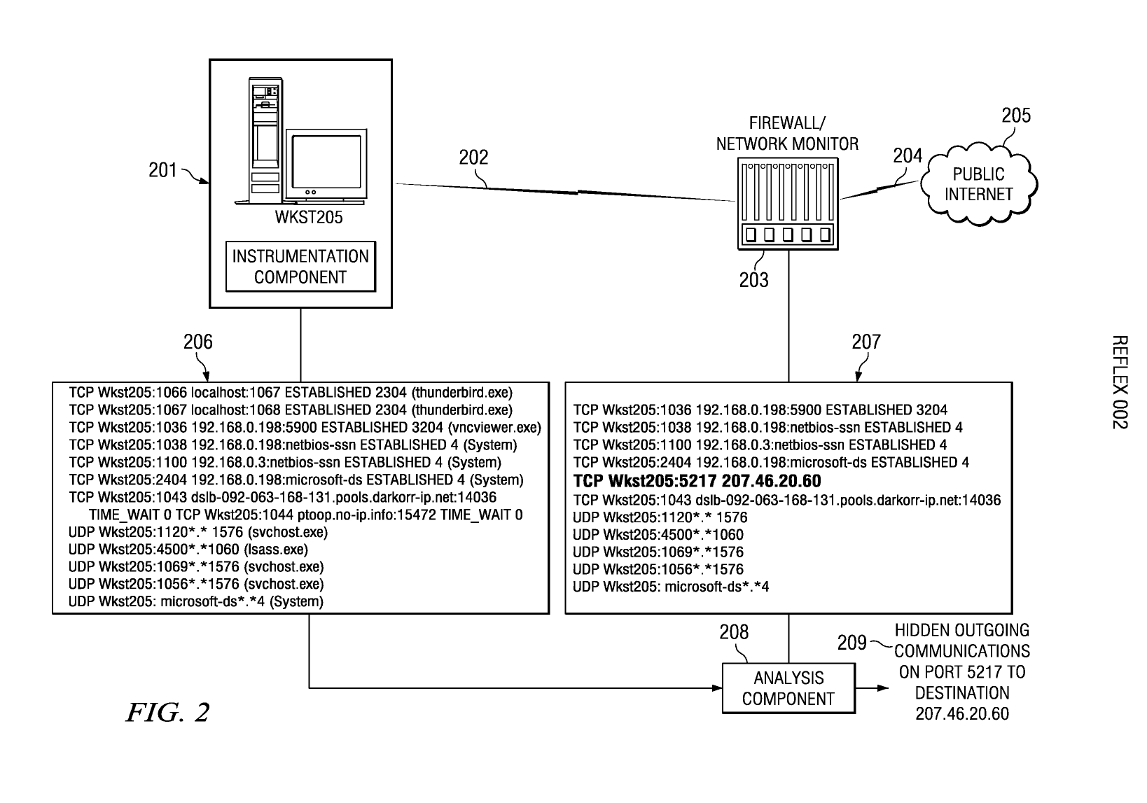

In particular, according to one aspect of the invention, a method for protecting the computer system (such as shown in FIG. 1) involves detecting discrepancies between communications activity by the system, as reported by instrumentation components of the system, and communication activity of the system, as reflected in data actually being received by or sent from the system, as reported by an external network monitor. In a representative embodiment, the external network monitor is “external” by virtue of being located outside of the computer system (or its particular components) that are being monitored for compromise. In such case, the external network monitor may be conveniently located within a firewall, a NAT device, a router, or some other device or system external to the computer system. (In some cases the external network monitor may be co-located within or in association with the computer system depending on the particular computer system functionality being monitored for compromise). As will be described, an analysis component (which may itself be located in the computer system, in the external network monitor, or elsewhere) then compares information about these two data streams (the information may be in the form of telemetry or batch data, or both, or in another form) to determine whether the computer system has been compromised. In particular, this analysis may be performed on a per-system, -application, -process, -thread, or other -code component. In one implementation, the discrepancies are detected in real-time. Such discrepancies are strong indications of an attack, or of an effort to hide an attack from detection: thus, they are direct indications of an attack that could otherwise be hidden and not detected. FIG. 2 illustrates this detection process.

In particular, this embodiment illustrates how detection is made based on violation of an invariant condition that relates network communications as seen by instrumentation within a system, to network communications as seen by instrumentation external to the system. For simplicity of presentation, this example embodiment describes functionality in terms of specific components that are familiar to most practitioners in Network Intrusions Detection or Protection Systems (NIDS/NIPS). The extension to other possible components or implementations will be readily apparent.

As illustrated in FIG. 2, computer system 201 is instrumented to add a real-time monitoring component that reports network communications that are being performed by the system. The actual communications to and from the computer system are carried out through the communications pathway 202. This pathway may be the communications occurring on a single Ethernet connection or NIC, or on a serial or parallel port, or the aggregate of multiple communications, or a virtualization of a number of communication pathways or an aggregate of any of these. The pathway may be wired, wireless, or over a LAN or WAN. The instrumentation component in the computer system 201 may be a loadable instrumentation module as described in US Patent Application 20060190218, by Agrawal et al. This is not a limitation of the invention, however. The component provides real-time or near real-time information about what communications are being done or what communication pathways are actively sending data, receiving data, or are ready to receive data (i.e., “listening”). The component may produce a continuous report of activity as it occurs, or it may produce a periodic real-time “snapshot” of what activity is going on at a given moment. For simplicity in presentation, the example given in FIG. 2 shows a snapshot 206 of communications activity as might be collected by the well-known Unix software component “netstat,” showing the type of communications (e.g., TCP, UDP, and the like), the port on the computer system (port “1038” on system “Wkst205”), and the target or other endpoint of the particular communication activity. In addition, this example shows the software application or process component that is generating the activity. As noted, the information may be gathered by the instrumentation component by any convenient means, such as hooking of certain system calls that are used for communications actions, by the well-known means of a “filter driver” that can monitor network-related invocations of other driver functions on the system, or by making of use of particular API functions that are provided on the system for the purpose of monitoring or taking a snapshot or other enumeration of network activity. The above techniques are merely representative.

An external monitor component 203 in this example preferably sits in-line on all of or on a portion of the network data that is communicated to and/or from the computer system. In this example, the external component may be a firewall system, a router, a NAT device, or another component that can function as a network monitor and report or monitor actual network communications data pass to/from the computer system 201. For the purposes of this example embodiment, the network monitor component 203 merely acts as a pass-through on the data from the computer system to a larger communications network, such as the public Internet or a private intranet.

As noted above, reference numeral 206 shows an example of a snapshot view of communications activity by the computer system, as reported by the instrumentation components of computer system 201. In contrast, reference numeral 207 shows an example of a snapshot view of communications activity reflected in data actually being received by or sent from the computer system, as reported by the external network monitor 203. Reference numeral 208 is an analysis component that compares the information of 206 with the information of 207. The analysis component may be located in the computer system itself, in the external monitor component, in another system (including a hosted or managed application service), or in any other machine, system or device. In this particular example, an analysis done by the component 208 detects a violation of a particular invariant condition, namely, that network activity as seen from within the computer system is invariantly reflected in corresponding network data seen by the network monitor. Reference numeral 209 illustrates a representative notification that detection (namely, a violation of the particular invariant condition) has occurred. Depending on the particular engineering needs, this notification may be sent to a human operator, logged for later analysis, or provided to an alert or other notification functionality.

In this example, and for the purposes of illustration, a “hidden” communication on port 5217 violates this invariant external condition. This communication is not otherwise visible to the instrumentation component within the computer system and thus would not be seen by prior art detection techniques.

This particular example embodiment reflects a real-world case, namely, that a root-kit or an attack payload or other unauthorized software has been introduced to the computer system 201 and is otherwise hiding its communications from detection, e.g., by a host-based firewall or other monitor. As noted above, there are many well-known techniques for hiding communications or other unauthorized activity, such as hooking of system APIs that report information about system objects. Such techniques are identified by the present invention.

It should be noted that, in this example, the analysis and detection is done in real-time or near-real-time. This is not a limitation of the present invention, however. The analysis could also be done after-the-fact using data that has been logged or recorded. There are advantages to doing the analysis and detection in real-time, however, as it allows this method to be used as part of a protective system, such as to automatically isolate or disable all or part of the communications to/from the computer system to limit attacks from the compromised system. There are also possible engineering reasons for preferring or providing the alternative of doing the analysis after-the-fact: for example, such an analysis might be part of a forensic investigation or study to determine the sequence of events and/or spread of attack in when multiple systems have been compromised.

An advantage of the current method is that it is not necessary to know how the system has been compromised. It is sufficient to detect the violation of an external invariant condition as noted above.

As will be readily apparent, there are numerous other possible implementations that are encompassed by the present invention. For example, invariant external conditions may be derived from the properties of a policy-based security system. For example, a policy-based system may be used to enforce privilege or other restrictions that state that only certain applications may service HTTP communications requests, and the policy-based system enforces this protective restriction in cooperation with the API software of the computer system. The API requests will only be granted if the particular application is one for which the policy-based system is programmed to permit the particular request. However, it may be possible that a policy-based system of this type may be subverted or bypassed through means unanticipated by the designer of the policy-based system. Thus, for example, it may be possible that HTTP requests may be serviced by means that do not use the APIs with which the policy-based system has been integrated. Or, it may be possible that another application may be subverted or misused to process HTTP requests, and the policy-based system (perhaps by an oversight having to do with “super-user” privileges or the like) does not deny that particular application's use of the particular API functions.

By applying the current invention, a new “invariant external condition” is derived, for example, that any communications of the form “process HTTP request” that are reported by instrumentation must be communications whose initiation would have been permitted or would not have been denied by the policy-based system. Any such communications that are then reported would be a violation of this additional invariant condition. The violation would be a direct indication of compromise, either of the policy-based system itself, or by some means which (in effect) bypassed the policy-based system.

Once it has been detected that an attack has been made, one or more remediation actions can be taken. Remediation actions are well known and familiar in the current art. Examples of remediation actions would include terminating a process for which some invariant condition is violated, denying continued operation with or use of data returned or obtained by an operation in which an invariant condition is violated, immediately invoking a separate (and more costly) analysis by means of an automated audit or scan of the system, reporting a notification to an existing IDS Intrusion Detection System or NIDS Network Intrusion Detection System, or making use of a firewall or router to other network control device to isolate the system which has been compromised from other systems on a network as a means for confining the compromise to only those systems already compromised. The discrepancy may also be used to provide a forensic analysis of a prior attack on the system.

The embodiment of FIG. 2 illustrates one embodiment of the invention, wherein comparison is done of network data collected at one layer of a communication framework to network data collected at another layer. In this approach, communications information is collected at the first (higher) layer (e.g., by an application, the OS kernel, or other location) and compared to data collected at the second (lower) level (e.g., by the kernel, external network device or other), to verify the consistency of the communications channel. An analysis component then compares information about these two data streams (which each may be in the form of real-time telemetry or batch data, or both) to determine whether the system (or application, process or other code functionality, as the case may be) has been compromised.

As also described above, another embodiment of the invention involves use of a model of network behavior for a given computer system component, typically a process. In this embodiment, as shown in FIG. 3, the network communications activity of a computer system process is intercepted or otherwise obtained by a modeling component 302. The modeling component 302 builds a model using known system modeling techniques such as ellipsoidal models, k-means models, decision tree models, support vector machine (SVM) models, Markov process models, correlation factor models, frequency threshold models, ellipsoidal models, and combinations thereof. A monitoring component 306 then compares real-time communications behavior for the process with the model to determine whether any discrepancy has occurred. In response, a given remedial action is taken.

Concerning the means of instrumentation, as noted above, in one embodiment the present invention uses a loadable instrumentation module to produce a telemetry stream of the network communications behavior as measured from the computer system. One reference to such a loadable instrumentation embodiment is US Patent Application 20060190218, by Agrawal et al. As also discussed above, other embodiments include such means as filter drivers for obtaining a telemetry stream for file and/or network operation, or hardware monitors or combinations of hardware/software monitors for reading properties of sub-systems or devices within the system. Moreover, as also discussed, the means for analysis of the network communications could be implemented directly in the system being tested.

Preferably, the inventive technique looks at networking activity on a per-process basis instead of on the network, where information about what process is performing what activity may be lost. This is desirable as many ports, such as http port 80, appear legal on a network but may be emanating from a non-web application that has been compromised. The inventive technique does not depend upon rules or access control lists for determining allowable network activity but instead provides information on new network usage, preferably based upon a model of the process's prior network activity. The model detection methodology may have specific logic code into it to determine the likelihood that this new activity is the result of an attack.

If desired, the above-described embodiment may be integrated with existing models for monitoring program behavior, such as statistical, Markov, and/or other behavioral models of system call activity. As noted above, such models also provide general (albeit “softer”) indications of a possible attack. The model of network behavior may be developed over time via machine learning or adaptive recognition.

It may also be desirable or advantageous to combine an embodiment of this current invention with an embodiment of other detection systems, such as that of the co-pending application Ser. No. 11/524,558, filed Sep. 21, 2006, titled “Detection of system compromise by correlation of information objects,” which may make use of invariant conditions relating to internal state or operations of one or more components. The disclosure of that application is incorporated herein by reference.

The techniques of this invention, which may correlate information about both internal (system) and external (network) behaviors, also could be used in conjunction with other, usually more limited “network anomaly” detection systems, such as the techniques described in “Detecting Wireless LAN MAC Address Spoofing” by Joshua Wright.

In another implementation, a kernel instrumentation program (KAI) monitors actions by application and other programs, including network communications performed by one or more applications on the system. This information is delivered to an agent, which then builds models of the network activity on a per-process basis. The agent then compares network events as they occur to the models and determines what, if any, remedial actions should be taken to protect the computer system. Thus, the invention detects a network operation behavior for a particular application and compares this information with network information behavior for the system on or in which the particular application is executing. The remedial action taken is preferably specific to the particular application.

The present invention has numerous advantages over the prior art. One advantage is that there are no rules or signatures to maintain or update for detecting attacks. Another advantage is simplicity of implementation. In particular, the class of techniques (as described above) are in many aspects relatively simple compared to the complexity of many other means, and thus may be considered more likely to have fewer errors in implementation. Still another advantage is simplicity of management. Because there are no aspects (or at least many fewer aspects) that could be considered as rules or policies that must be configured, the management burden on the user is much less. A further advantage is the feasibility of real-time implementation. In particular, the techniques can be implemented as real-time detection without placing a significant performance burden on the system or application. The invention has the further advantage of being difficult to bypass. In this regard, because all remote attacks must use network communications as the medium of communication to the exploited application, it is critical that reliable detection methodologies be implemented in this space. The ability to assign network behavior to specific applications provides us with more information which we can use to determine the likelihood of an attack. The invention has the further advantage of its generality. In particular, the detection is not specific to any particular means for hiding an attack, but instead detects any attack that causes a visible inconsistency the network activity of an application. Finally, the invention is advantageous given the ease with which it can be integrated with other forms of analysis. In particular, the technique provides what may be considered strong indicators of attack behavior. As indicators of attack behavior, they can be integrated with more general models of behavior which provide harder or softer indications of possible attack. Especially when the models use much of the same instrumentation, and the management of the detector implementation is also much the same, the cost of the detector system remains low, and the likelihood of detecting attack is improved overall.

The invention may be implemented in any computer environment, but the principles are not limited to protection of computer systems. In a representative implementation, the invention is implemented in a set of one or more computing-related entities (systems, machines, processes, programs, libraries, functions, or the like) that facilitate or provide the described functionality. A representative machine on which a component of the invention executes is a client workstation or a network-based server running commodity (e.g., Pentium-class) hardware, an operating system (e.g., Windows XP, Linux, OS-X, or the like), optionally an application runtime environment, and a set of applications or processes (e.g., native code, linkable libraries, execution threads, applets, servlets, or the like, depending on platform) that provide the functionality of a given system or subsystem. The method may be implemented as a standalone product, or as a managed service offering, or as an integral part of the system. As noted above, the method may be implemented at a single site, or across a set of locations in the system. Of course, any other hardware, software, systems, devices and the like may be used. More generally, the present invention may be implemented in or with any collection of one or more autonomous computers (together with their associated software, systems, protocols and techniques) linked by a network or networks. All such systems, methods and techniques are within the scope of the present invention.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the present invention has been described in the context of a method or process, the present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A given implementation of the present invention is software written in a given programming language that runs on a standard hardware platform running an operating system.

While given components of the system have been described separately, one of ordinary skill will appreciate that some of the functions may be combined or shared in given instructions, program sequences, code portions, and the like.

Having described our invention, what we now claim is as follows:

1. A method of protecting a system, comprising:
for a given process, comparing first and second network activity;
determining whether a discrepancy exists between the first and second network activities; and
if a discrepancy exists between the first and second network activities, taking a given remedial action to protect the system.

2. The method as described in claim 1 wherein the first network activity is a model of network communication behavior associated with the given process that is derived by intercepting network communications within an operating system kernel or other application.

3. The method as described in claim 2 wherein the second network activity is data indicative of network communication behavior that is derived by monitoring network communications associated with the given process.

4. The method as described claim 1 wherein the first network activity is derived from network communication data collected at a first layer of a communications system.

5. The method as described in claim 4 wherein the second network activity is derived from network communication data collected at a second layer of the communications system.

6. The method as described in claim 5 wherein the first layer is a and the second network activity is network communication data collected and the comparison is done of network data collected at one layer of a communication system to network-related data collected at another layer.

7. The method as described in claim 1 wherein the given remedial action is one of: replacing a component that has been compromised with a known good copy of the component, isolating the computer system to prevent spread of the compromise to other systems, restricting access to the component that has been compromised, issuing a given notification, performing further detection or analysis, and isolating the component that has been compromised.

8. The method as described in claim 1 wherein the discrepancy is used to provide a forensic analysis of a prior attack on the system.

9. A method of protecting a computer system, comprising:
detecting discrepancies between communications activity by the system as reported by instrumentation components of the system and prior communications activity of the system as reflected in a model of network behavior; and
taking a given action to protect the system in response to the detecting step.

10. The method as described in claim 9 wherein the given action is one of: replacing a component that has been compromised with a known good copy of the component, isolating the computer system to prevent spread of the compromise to other systems, restricting access to the component that has been compromised, issuing a given notification, performing further detection or analysis, and isolating the component that has been compromised.

11. The method as described in claim 9 further including updating the model on a periodic basis.

12. A method of protecting a system, comprising:
comparing local and remote observations of the system's associated network communications behavior, wherein the local observation of the system's associated network communications behavior is generated by instrumentation local to the system, and wherein the remote observation of the system's associated network communications behavior is generated by instrumentation external to the system; and
based on the comparison, determining whether a given component in the system has been compromised.

13. The method as described in claim 12 wherein the remote observation is carried out in a device external to the system.

14. The method as described in claim 13 wherein the device is one of a firewall, a NAT device, a router, and a computer system other than the system.
